(19) United States
(12) Patent Application Publication
(10) Pub. No.: US 2026/0295802 A1
(43) Pub. Date: Oct. 1, 2026

(54) DIRECTIONAL SWITCH INTERLOCK FOR A POWER TOOL

(71) Applicant: Ingersoll-Rand Industrial U.S., Inc., Davidson, NC (US)

(72) Inventors: Kevin M Purdy, Charleston, SC (US); Justin T Chellew, Bethlehem, PA (US); Wei Dai, Nanjing (CN)

(21) Appl. No.: 19/091,044

(22) Filed: Mar. 26, 2025

(51) Int. Cl. B25F 5/02; H01H 9/06; H01H 9/20

(52) U.S. Cl. CPC B25F 5/02; H01H 9/063; H01H 9/20

(57) ABSTRACT

A power tool has a directional switch interlock. The power tool includes a drive mechanism having an output shaft that is configured to rotate about a rotational axis in a clockwise direction or a counterclockwise direction. A directional switch is configured to select the rotational direction of the output shaft between the clockwise direction and the counterclockwise direction. A trigger member of the power tool is configured to be actuated from a non-actuated position to an actuated position to cause the drive mechanism to rotate the output shaft about the rotational axis. The trigger member includes a directional switch-locking member, where when the trigger member is actuated from the non-actuated position to the actuated position, the directional switch-locking member engages with the directional switch, locking the directional switch from changing the selected rotational direction of the output shaft.

### CROSS-REFERENCE TO RELATED APPLICATIONS

U.S. patent application Ser. No. 18/615,476 titled “MULTIPLE POSITION NON-CONTACT TRIGGER SYSTEM FOR A POWER TOOL” filed on Mar. 25, 2024 is incorporated by reference herein in its entirety.

### BACKGROUND

Impact tools are power tools configured to deliver a high torque output by storing energy in a rotating mass and delivering it suddenly through an output shaft to a fastener. As impact tools are used in applications that require high cycle counts, the vibration of the tool may cause unwanted setting changes.

### DRAWINGS

The Detailed Description is described with reference to the accompanying figures. The use of the same reference numbers in different instances in the description and the figures may indicate similar or identical items.

FIG. 1 is a cross-sectional isometric view of a power tool having an impact assembly and a directional switch interlock in accordance with example embodiments of the present disclosure.

FIG. 2 is a partial cross-sectional side view of the power tool, such as the one shown in FIG. 1, having a directional switch and a trigger member, the trigger member disposed at a non-actuated position in accordance with example embodiments of the present disclosure.

FIG. 3 is a partial front view of the trigger member and the directional switch, such as the one shown in FIG. 2, where the directional switch is pushed in a first position and the trigger member is pulled to an actuated position, in accordance with example embodiments of the present disclosure.

FIG. 4 is a partial front view of the trigger member and the directional switch, such as the one shown in FIG. 2, where the directional switch is pushed in a second position and the trigger member is pulled to an actuated position, in accordance with example embodiments of the present disclosure.

FIG. 5 is a partial isometric view of the power tool, such as the one shown in FIG. 1, where the directional switch is pushed in a first position and the trigger member is pulled to an actuated position, in accordance with example embodiments of the present disclosure.

FIG. 6 is a partial front view of the trigger member and a directional switch, where the directional switch is pushed in a first position and the trigger member is pulled to an actuated position, in accordance with other example embodiments of the present disclosure.

### DETAILED DESCRIPTION

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

### Overview

Impact tools (e.g., impact wrenches, etc.) deliver a high torque output with minimal exertion by the user. These tools employ a rotating mass, or hammer, that stores energy and abruptly delivers the stored energy to an anvil connected to an output shaft, subjecting the anvil to repeated and sudden shock loading. Impact fastening tools, particularly battery-operated impact fastening tools, employ a trigger that is actuated (depressed or pulled) by the user to initiate a fastening operation. Prior to actuation, the user may further select a directional input (direction of rotation-clockwise or counterclockwise) via directional switch positioned above the trigger to drive the fastening in the desired direction. Power tools may employ either a contact switch/contact trigger system or a non-contact switch/non-contact trigger system to operate (i.e., actuate the drive system of) the power tool.

Impact fastening tools, employing either contact and non-contact trigger systems, can experience inadvertent actuation (shuttling) of the directional switch while the power tool is operational (e.g., the trigger is pulled). This shuttling may cause the output shaft to rotate in a direction opposite the desired direction, thereby driving the fastener the fastener in a direction opposite the intended direction (e.g., loosening the fastener instead of tightening the fastener). Inadvertent shuttling of the directional switch thus wastes time as the operator changes the directional switch to the previously established rotational direction, and could potentially cause damage the fastener or workpiece. Unwanted shuttling of the directional switch can be caused by vibration of the power tool, or through inadvertent contact of the switch by the user's hand and/or workpiece materials during operation.

Accordingly, the present disclosure is directed to a power tool, for example an impact tool, having a directional switch interlock. The power tool includes a trigger system configured to control the actuation of the power tool drive mechanism, and a directional switch configured to be used to determine the rotational direction of the output shaft of the power tool. The trigger system includes a trigger member having a trigger cap proximate to the directional switch. The directional switch interlock includes a directional switch-locking member mounted on the trigger cap of the trigger member and a trigger-engaging portion disposed on an underside of the directional switch, proximate to the trigger member. Through the directional switch interlock, the trigger member is configured to block the directional switch to shuttling to an unwanted position once the trigger member is actuated. When the trigger member is actuated (e.g., depressed, pulled, squeezed, or pushed), the directional switch-locking member lines up adjacent to the trigger-engaging portion, and becomes a contacting surface that physically stops the directional switch from changing the rotational direction of the output shaft, be it by vibration of the power tool or through inadvertent contact to the directional switch.

### Detailed Description of Example Embodiments

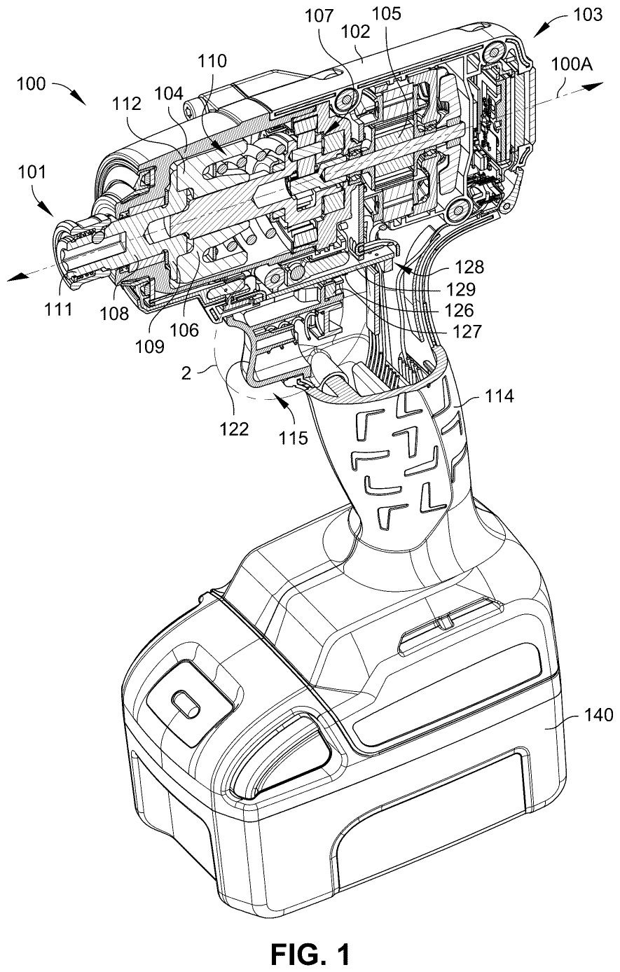

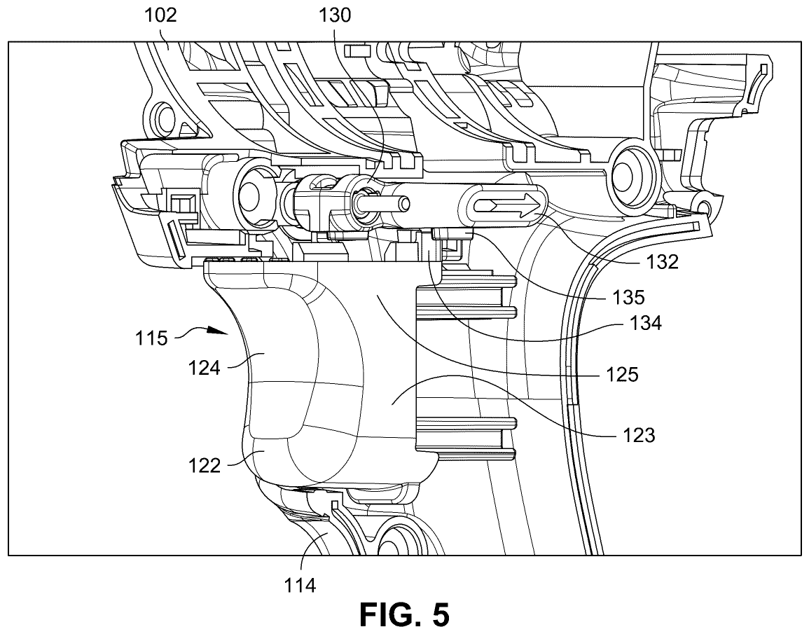

Referring generally to FIGS. 1 through 6, a power tool assembly 100 having a directional switch interlock is described. FIG. 1 shows an illustrative embodiment of a power tool assembly 100 in accordance with the present disclosure. The impact tool includes a housing 102 having a front end 101 and a rear end 103. The power tool assembly 100 includes a hammercase 104 that houses an impact assembly 110. The housing 102 includes a drive mechanism 105 that rotates a hammer 106 of the impact assembly 110 around an output axis 100A. The output axis 100A extends from the front end 101 to the rear end 103. The housing may include a gear set assembly 107 connecting the drive assembly 105 with the hammer 106. The housing 102 shown employs a pistol grip design wherein a handle 114 comprises a pistol type grip that is generally perpendicular to the output axis 100A. In other embodiments, the handle 114 may be parallel to (e.g., coaxial with) the output axis 100A. In embodiments, the drive assembly 105 may be generally perpendicular to the output axis 100A. In other embodiments, the drive assembly 105 may be parallel to (e.g., coaxial with) the output axis 100A.

In the embodiment illustrated, the power tool assembly 100 comprises an impact wrench. However, those of skill in the art will understand that the power tool assembly 100 is not limited to an impact wrench and that a variety of different elements may be used. For example, other power tools suitable for use by the power tool assembly 100 can include fastening tools used for fastening and unfastening threaded fasteners such as, but not limited to, impact drivers, nut runner tools, pulse wrenches, grinders, drills, combination hammers, screwdrivers, clutch tools, and so forth. In embodiments, the power tool assembly 100 may include right-angle tools such as nut runners or right angle impact tools. In embodiments, the drive mechanism 105 comprises an electric motor powered by a power source such as a removable battery 140, an internal battery, or an external power source via an electric cord (not shown). However, it is contemplated that the rotary power tool assembly 100 may also comprise a pneumatic tool having a drive mechanism 105 employing a pneumatic (compressed air) motor powered by a source of compressed air.

The hammer 106 includes at least one hammer jaw 112. The impact assembly 110 further includes an anvil 108 disposed inside the hammercase 104. The anvil 108 includes at least one anvil jaw 109 configured to be repeatedly struck by the at least one hammer jaw 112. The hammer 106 continuously and intermittently impacts the anvil 108, causing it to continually rotate. An output shaft 111 extends from the anvil 108 and may receive a connector or other device that engages a fastener (e.g., a bolt, a nut, a screw, etc.) to be tightened or loosened. The output shaft 111 rotates about the output axis 100A in one of a clockwise direction or a counterclockwise direction.

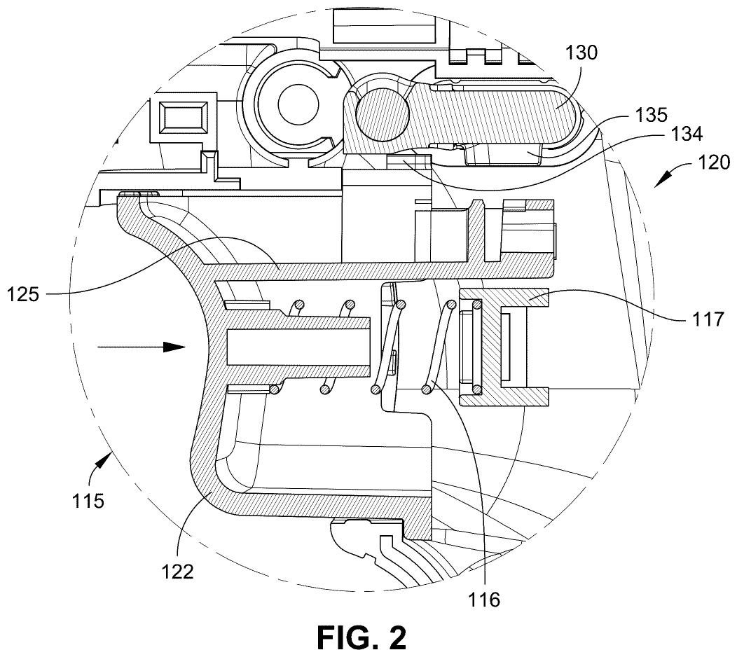

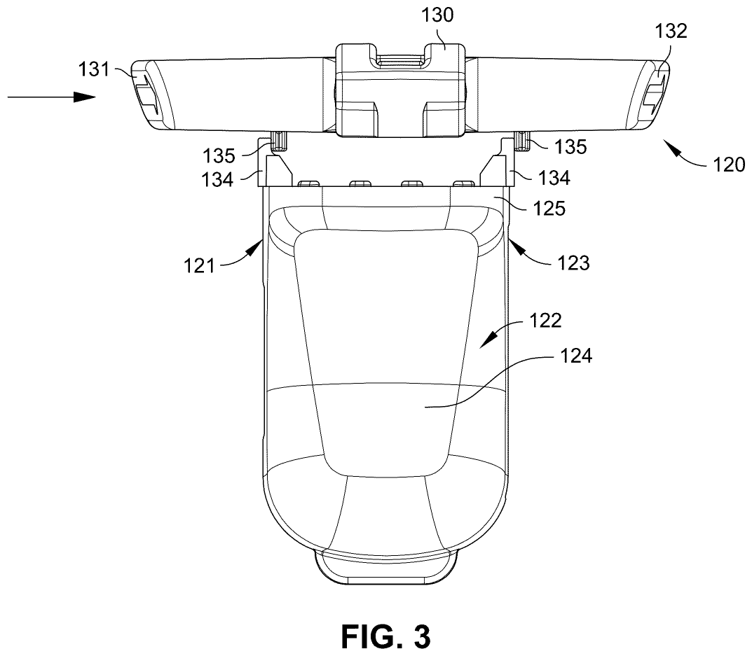

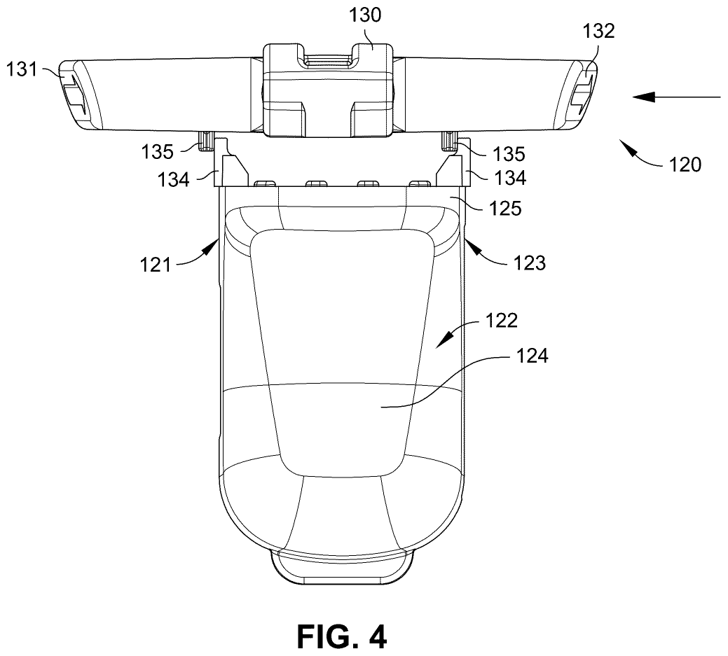

As shown in FIGS. 2 through 6, the power tool assembly 100 includes a directional switch 130, a trigger system 115, and a directional switch interlock 120. The directional switch 130 includes a first directional switch portion 131 and a second directional switch portion 132 configured to be pushed by the user to select a rotational direction of the output shaft 111. The directional switch 130 may be actuated by the user by pushing the first directional switch portion 131 (FIG. 3) to select the clockwise rotational direction of the output shaft 111. The directional switch 130 may be actuated by the user by pushing the second directional switch portion 132 (FIG. 4) to select the counterclockwise rotational direction of the output shaft 111. It should be understood that in other embodiments pushing the first directional switch portion 131 may select the counterclockwise rotational direction of the output shaft 111 and pushing the second directional switch portion 132 may select the clockwise rotational direction of the output shaft 111.

The trigger system 115 includes a trigger member 122 and a biasing member 116 disposed proximate to the handle 114 in the housing. The trigger member 122 is configured to be actuated by a user from a non-actuated position to an actuated position. The trigger system 115 controls the actuation of the drive mechanism 105. When the trigger member 122 is actuated, the output shaft 111 is configured to rotate in the direction selected through the directional switch 130. If no rotational direction is selected by the user through the directional switch 130, actuation of the trigger member 130 may not actuate the drive mechanism 105.

The trigger member 122 includes a first side wall 121, a second side wall 123, a front face 124, and a trigger cap 125. The front face 124 connects the first side wall 121 and the second side wall 123 and is the user-contacting surface of the trigger member 122. The trigger cap 125 is disposed on top of the first side wall 121, the second side wall 123, and the front face 124, and is proximate to the directional switch 130.

The directional switch interlock 120 includes a directional switch-locking member 134 disposed on the trigger cap 125 and a trigger-engaging portion 135 disposed on the directional switch 130. The directional switch-locking member 134 is configured to engage with the directional switch 130 when the trigger member 122 is actuated from the non-actuated position to the actuated position, thereby locking the directional switch 130 in the rotational direction that was selected by the user prior to actuating the trigger member 122.

FIGS. 3 and 4 show the directional switch-locking member 134 forming an elongated rib extending from the trigger cap 125 supported by both the first side wall 121 and the second side wall 123. In other embodiments, the directional switch-locking member 134 may extend directly from at least one of the first side wall 121 and the second side wall 123. In yet other embodiments, the directional switch-locking member 134 may extend in the middle of the trigger member 122 supported by an internal surface or an internal structure of the trigger member 122 or along the length of the trigger member 122 between the first side wall 121 and the second side wall 123. In other embodiments, the directional switch-locking member 134 may have a different shape, such as, but not limited to, a cylindrical peg, a squared or faceted extrusion, a ring-shape, among others.

In the embodiment shown in FIGS. 3 and 4, the directional switch 130 includes a trigger-engaging portion 135. The trigger-engaging portion 135 may be a protruding tab that extends from an underside of the directional switch 130, proximate to the trigger member 122. It should be understood that the location of the trigger-engaging portion 135 could be different than the underside of the directional switch 130 in embodiments where the tool is not a pistol-type power tool. In embodiments, the location of the trigger-engaging portion 135 corresponds to a side of the directional switch 130 that is proximate to the trigger member 122.

The trigger-engaging portion 135 may extend along the directional switch 130, in a direction extending from the front end 101 to a direction extending towards the rear end 103, in other words, in a direction parallel to the actuation direction of the trigger member 122. This arrangement allows the directional switch-locking member 134 to slide directly next to the trigger-engaging portion 135 when the trigger member 122 is actuated. The directional switch-locking member 134 becomes a physical obstruction that prevents the directional switch 130 to slide back to a neutral position in the middle of the power tool housing 102 or change the rotational direction of the output shaft 111.

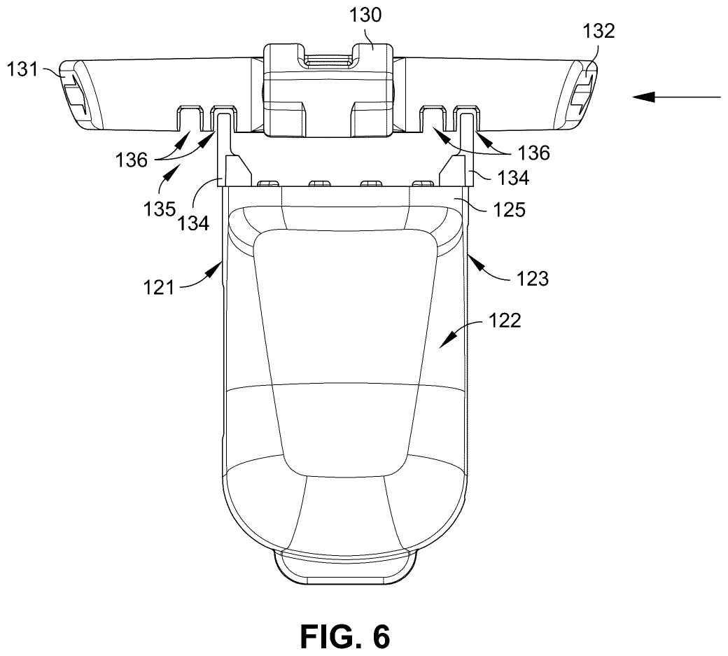

In other embodiments, the trigger-engaging portion 135 includes at least one channel 136 defined on the directional switch 130, proximate to the trigger member 122. The at least one channel 136 is configured to receive the directional switch-locking member 134 as the trigger member 122 is pulled towards the actuated position. Once the channel 136 receives the directional switch-locking member 134, the internal walls of the channel 136 act as a stopping surface that prevents the directional switch 130 from shuttling and changing the rotational direction of the output shaft 111. FIG. 6 shows a directional switch 130 including two (2) channels 136 for each directional switch-locking member 134. In this embodiment, one channel 136 aligns with the directional switch-locking member 134 when the directional switch 130 is positioned in the clockwise direction of rotation and another channel 136 aligns with the directional switch-locking member 134 when the directional switch 130 is positioned in the counterclockwise direction of rotation.

In other embodiments (not shown), the shape of the directional switch-locking member 134 may include a curved tab having a tab end pointing towards the read end 103. The tab end of the directional switch-locking member 134 may engage with the trigger-engaging portion 135. In embodiments, the trigger-engaging portion 135 may be an orifice, a ring, an indentation, a slit, a cavity, etc. defined on the directional switch 130 configured to receive the directional switch-locking member 134.

In example embodiments, the trigger system 115 is a non-contact trigger system that includes a sensor assembly 128 having a circuit board 129 mounted on or in the housing 102. The circuit board 129 includes at least one non-contact sensor 126 connected therewith. The trigger system 115 may include a magnet 127 mounted on the trigger member 122. As the trigger member 122 is pulled against the handle 114 and partially actuated or fully actuated, the magnet 127 moves relative to the at least one sensor 126. In other embodiments, the non-contact sensors may be coupled to the trigger member 122 while the magnet 127 may be mounted on the housing 102. In other embodiments, the trigger system 115 may include a plurality of magnets. The plurality of magnets may be identical to each other or vary in size, shape, and/or magnetic strength.

In an example embodiment, one or more of the at least one non-contact sensors 126 comprise a Hall Effect sensor. Hall effect sensors may be selected from a group including Hall switches, linear Hall sensors, direct angle sensors, or any combination thereof. Hall switches are Hall effect sensors that measure and compare the strength of the magnetic field of a magnet up to a predetermined or fixed threshold level in the sensor. As the value of the threshold level is exceeded, an output transistor of the Hall switch may be switched on or off, depending on the desired application. Hall switches may include simple switches, double plate switches, and programmable switches. Linear Hall sensors provide proportional outputs based on the magnetic field strength of the magnet. Compared to Hall switches, linear Hall sensors do not have a discrete switching state and provide a signal that is linearly proportional to the strength of the magnetic field. Direct angle Hall sensors compare sine and cosine measurements of the magnetic field instead of measuring the absolute magnetic field. It should be understood that the plurality of non-contact sensors may all be selected as one type of Hall effect sensor or as a combination of the different types of Hall effect sensors previously discussed. In other embodiments, the non-contact sensors may be magnetorestrictive sensors or other sensors that receive and analyze a signal from a magnetic field.

In the embodiments illustrated, the trigger member 122 is biased towards the direction of the front end 101 of the power tool assembly 100 by the biasing member 116. In embodiments, the biasing member 116 may be a helical compression spring. It is contemplated that other biasing mechanisms may be used to bias the trigger member 122 in the direction of the front end 101 of the power tool 100. As a user pulls the trigger member 122 towards the direction of the rear end 103 of the power tool 100, the biasing member 116 may be compressed against a support member 117. The biasing member 116 may be at least one of a helical spring, a coil spring, a torsion spring, a lead spring, among others. In other embodiments, the biasing mechanism 116 may be a non-contact biasing mechanism. For example, an inner surface of the trigger member 122 and the support member 123 may include magnets configured to repel each other, thereby biasing the trigger member 122 to the non-actuated position shown in FIG. 2. The magnets may include permanent magnets or electromagnets. In other embodiments, the biasing member 116 may include air cylinders.

The trigger system 115 may include multiple trigger points, or predetermined positions along the travel distance of the trigger element 122 as it is moved from the non-actuated position (FIG. 2) to the fully actuated position (e.g., where the biasing member 116 is fully compressed against the support member 117). The at least one non-contact sensor 126 senses the movement of the trigger element 122 and commands the power tool assembly 100 to perform one of a plurality of functions depending on the trigger point reached or the position of the magnet with respect to the at least one sensor 126. In these embodiments, the directional switch interlock 120 engages the trigger member 122 with the directional switch 130 along each of the predetermined positions along the travel distance of the trigger element 122 as it travels from the non-actuated position to the fully actuated position.

In the preceding description, it is understood that terms such as “first,” “second,” “top,” “bottom,” “up,” “down,” “above,” “below,” and the like, are words of convenience and are not to be construed as limiting terms.

While the subject matter has been illustrated and described in detail in the drawings and foregoing description, the same is to be considered as illustrative and not restrictive in character, it being understood that only example embodiments have been shown and described and that all changes and modifications that come within the spirit of the subject matters are desired to be protected. In reading the claims, it is intended that when words such as “a,” “an,” “at least one,” or “one of a plurality of” are used there is no intention to limit the claim to only one item unless specifically stated to the contrary in the claim. Unless specified or limited otherwise, the terms “mounted” and “connected” and variations thereof are used broadly and encompass both direct and indirect mountings, connections, and couplings. Further, “connected” is not restricted to physical or mechanical connections or couplings.

1. A power tool comprising:
a housing;
a drive mechanism disposed in the housing, the drive mechanism including an output shaft configured to rotate about a rotational axis in one of a clockwise direction and a counterclockwise direction;
a directional switch configured to select a rotational direction of the output shaft between the clockwise direction and the counterclockwise direction; and
a trigger member configured to be actuated from a non-actuated position to an actuated position to cause the drive mechanism to rotate the output shaft about the rotational axis, the trigger member including a rib extending longitudinally along a side wall of the trigger member,
wherein when the trigger member is actuated from the non-actuated position to the actuated position, the rib engages with the directional switch, locking the directional switch from changing the selected rotational direction of the output shaft.

2. The power tool according to claim 1, wherein the directional switch includes a protrusion, the protrusion configured to engage with the rib when the protrusion is in the actuated position and the directional switch is pushed in one of a first position or a second position, where the first position corresponds to the clockwise direction of rotation and the second position corresponds to the counterclockwise direction of rotation of the output shaft.

3. The power tool according to claim 2, wherein the trigger member includes a trigger cap, and wherein the rib is disposed on top of the trigger cap.

4. (canceled)

5. The power tool according to claim 2, wherein the protrusion is disposed on an underside of the directional switch, where the underside of the directional switch is proximate to the trigger member.

6. The power tool according to claim 5, wherein the protrusion comprises a protruding tab configured to engage a side of the rib.

7. The power tool according to claim 5, wherein the protrusion comprises a channel defined on the underside of the directional switch, the channel configured to receive the rib.

8. The power tool according to claim 2, wherein the trigger member includes a second rib configured to engage with a corresponding second protrusion.

9. The power tool according to claim 1, wherein the trigger member includes a magnet configured to be sensed by a non-contact sensor disposed in the power tool housing.

10. A directional switch interlock for a power tool, the directional switch interlock comprising:
a directional switch configured to select a rotational direction of an output shaft of the power tool, the rotational direction selected between a clockwise direction and a counterclockwise direction; and
a trigger member configured to be actuated from a non-actuated position to an actuated position to energize the power tool to cause rotation of the output shaft, the trigger member including a rib extending longitudinally along a side wall of the trigger member,
wherein when the trigger member is actuated from the non-actuated position to the actuated position, the rib engages with the directional switch, locking the directional switch from changing the selected rotational direction of the output shaft.

11. The directional switch interlock system according to claim 10, wherein the directional switch includes a protrusion, protrusion configured to engage with the rib when the trigger member is in the actuated position and the directional switch is pushed in one of a first position or a second position, where the first position corresponds to the clockwise direction of rotation and the second position corresponds to the counterclockwise direction of rotation of the output shaft.

12. The directional switch interlock system according to claim 11, wherein the trigger member includes a trigger cap, and wherein the rib is disposed on top of the trigger cap.

13. (canceled)

14. The directional switch interlock system according to claim 11, wherein the protrusion is disposed on an underside of the directional switch, where the underside of the directional switch is proximate to the trigger member.

15. The directional switch interlock system according to claim 14, wherein the protrusion comprises a protruding tab configured to abut with a side of the rib.

16. The directional switch interlock system according to claim 14, wherein the protrusion comprises a channel defined on the underside of the directional switch, the channel configured to receive the rib.

17. The directional switch interlock system according to claim 11, wherein the trigger member includes a second rib configured to engage with a corresponding second protrusion.

18. The directional switch interlock system according to claim 10, wherein the trigger member includes a magnet configured to be sensed by a non-contact sensor disposed in the power tool housing.

19. A power tool comprising:
a housing;
a drive mechanism disposed in the housing, the drive mechanism including an output shaft configured to rotate about a rotational axis in one of a clockwise direction and a counterclockwise direction;
a directional switch configured to select a rotational direction of the output shaft between the clockwise direction and the counterclockwise direction; and
a trigger system including:
a trigger member configured to be actuated from a non-actuated position to an actuated position to cause the drive mechanism to rotate the output shaft about the rotational axis, the trigger member including a rib extending longitudinally along a side wall of the trigger member,
a magnet coupled to the trigger member, and
at least one non-contact sensor disposed in the housing proximate to the trigger member,
wherein when the trigger member is actuated from the non-actuated position to the actuated position, the rib engages with the directional switch, locking the directional switch from changing the selected rotational direction of the output shaft.

20. The power tool according to claim 19, wherein the directional switch includes a protrusion, the protrusion configured to engage with the rib when the trigger member is in the actuated position and the directional switch is pushed in one of a first position or a second position, where the first position corresponds to the clockwise direction of rotation and the second position corresponds to the counterclockwise direction of rotation of the output shaft.
